(19) United States
(12) Patent Application Publication
(10) Pub. No.: US 2024/0324546 A1
(43) Pub. Date: Oct. 3, 2024

(54) Pet Carrier

(71) Applicant: Richard A. Carmody, III, Ringgold, GA (US)

(72) Inventor: Richard A. Carmody, III, Ringgold, GA (US)

(21) Appl. No.: 18/613,768

(22) Filed: Mar. 22, 2024

Related U.S. Application Data
(60) Provisional application No. 63/455,643, filed on Mar. 30, 2023.

(51) Int. Cl. A01K 1/02

(52) U.S. Cl. CPC A01K 1/0245

(57) ABSTRACT

A pet carrier has a compact configuration somewhat like a suitcase in nature, and an open configuration somewhat like a tent in nature. The pet carrier can have an extendable handle and wheels to be rolled to a desired location, and then deployed for use in containing a pet in the enclosure therein.

### CLAIM OF PRIORITY

This application claims the benefit of U.S. Provisional Patent Application No. 63/455,643 filed Mar. 30, 2023, which is incorporated herein by reference in its entirety.

### FIELD OF THE INVENTION

The present invention relates to a pet carrier for use with transporting and/or containing pets on location.

### BACKGROUND OF THE INVENTION

There are numerous pet carrier device in the marketplace that may be utilized to transport pets. There are also a number of pet crates available in the marketplace. In spite of the proliferation of products available in the marketplace, the applicant believes that an improved product is still desirable for the marketplace.

### SUMMARY OF THE INVENTION

Accordingly, it is an object of many embodiments of the present invention to provide an improved pet carrier.

It is an object of many embodiments of the present invention to provide an improved pet cage.

Accordingly, in accordance with the presently preferred embodiment of the present invention, a pet carrier which may also be utilized as a pet cage or crate provides a closed configuration for compact storage. Sides of the carrier preferably contract to provide somewhat of a suitcase style or thin storage configuration. In an in-use configuration, the sides may be extended outwardly to provide more of a tent or dome shaped configuration where a door in a side may be open to allow for a pet to enter and then the device can be moved or carried by a top handle.

Additionally, optional wheels whether retractable, or not, may extend from the bottom so that the device may be rolled. A top handle may pivotably rotate relative to a base to allow for the carrier to be pulled although other embodiments could be pushed. When pulling, an upward force tends to be applied which can assist in moving the pet carrier particularly when a pet is in the carrier.

### BRIEF DESCRIPTION OF THE PREFERRED EMBODIMENT

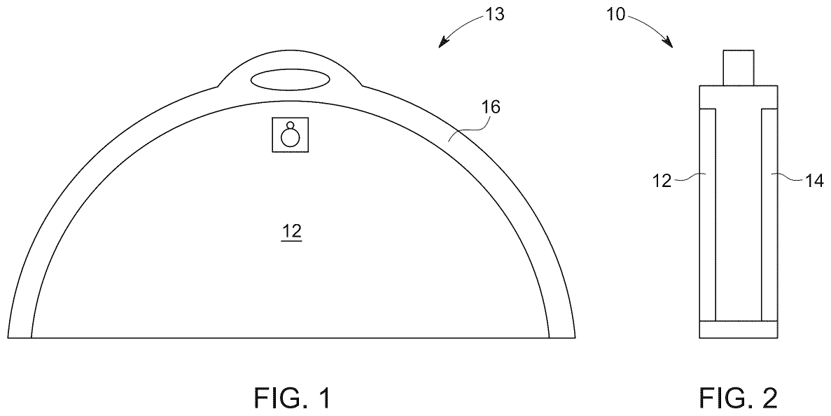

FIG. 1 is a front view of a pet carrier of the presently preferred embodiment in a closed configuration;

FIG. 2 is a side plan view of the pet carrier of FIG. 1;

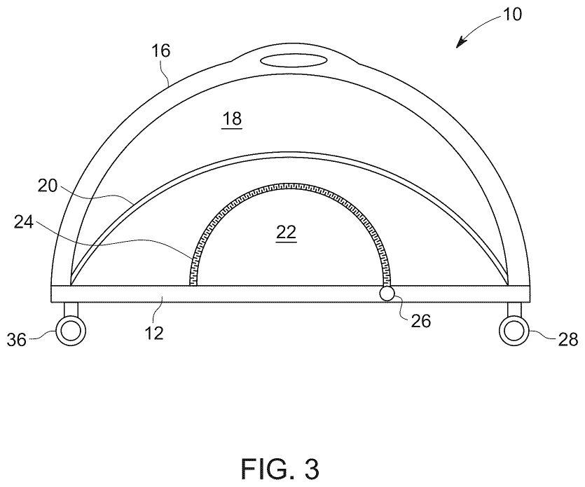

FIG. 3 is a front plan view of the pet carrier of FIG. 1 in an open configuration;

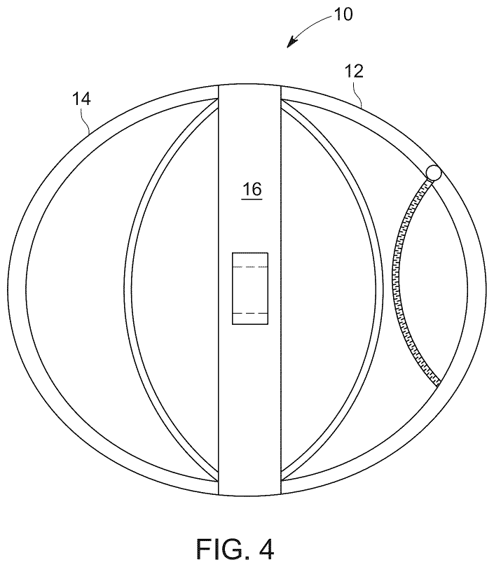

FIG. 4 is a top plan view of the pet carrier of FIG. 1-3 in an open configuration;

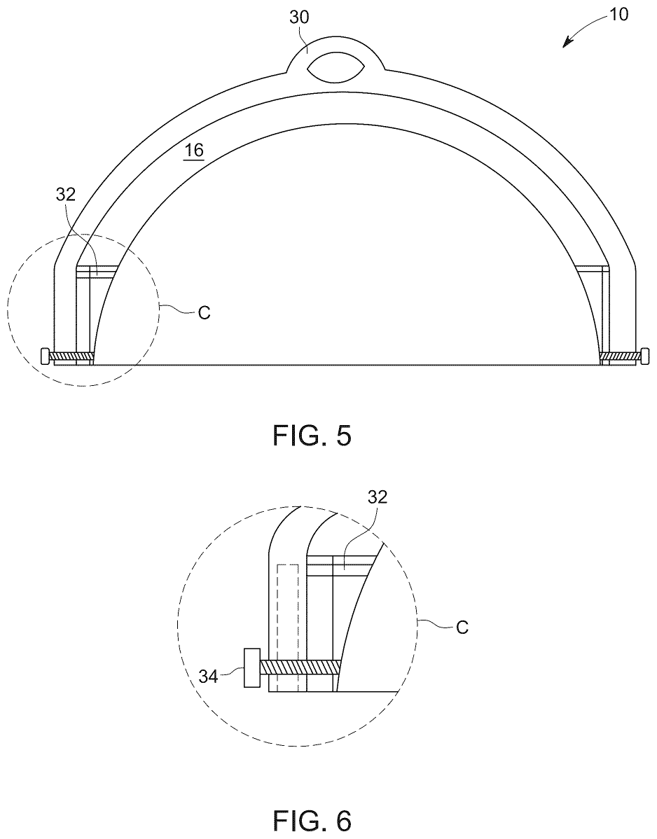

FIG. 5 is a front cross-sectional view of the pet carrier showing the handle in a closed configuration;

FIG. 6 is detail C taken from FIG. 5 showing the operational characteristics of the handle;

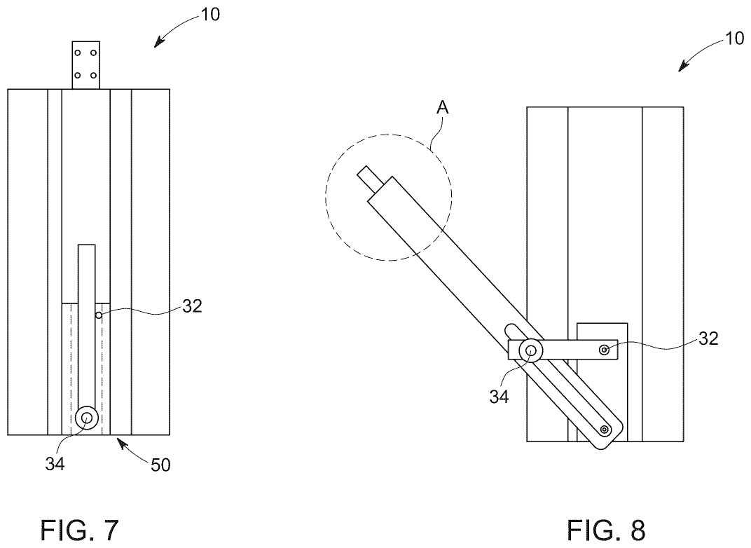

FIG. 7 is a cutaway version showing operational portions of the handle in a closed configuration;

FIG. 8 shows the handle in a pivoted configuration;

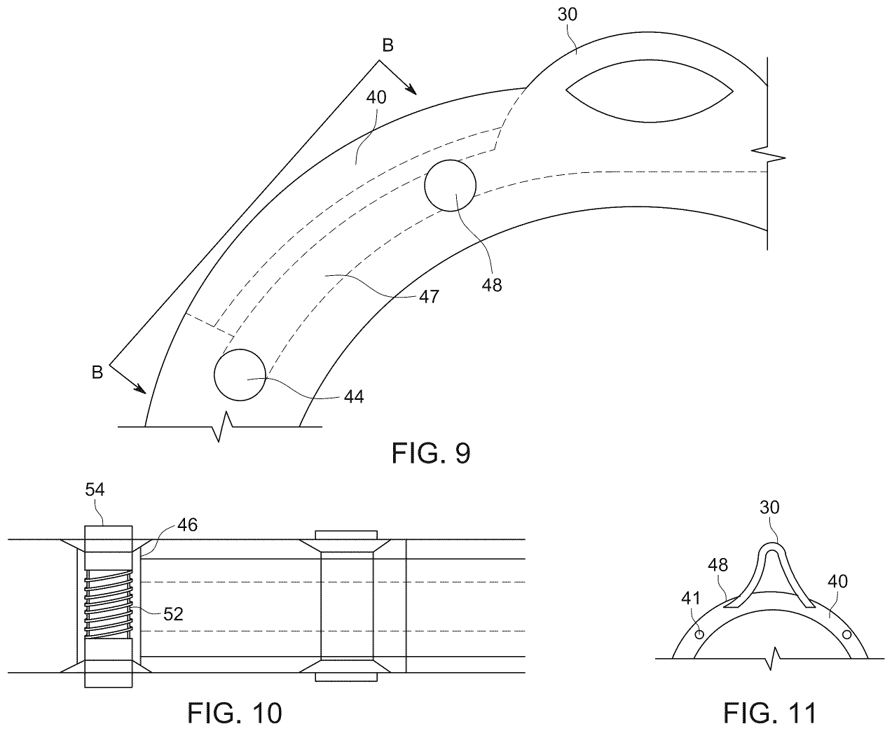

FIG. 9 shows a detail A of the handle with internal portions shown in phantom;

FIG. 10 shows a cross-sectional view taken along line BB of FIG. 9 showing the operational characteristics of the handle;

FIG. 11 shows the handle in the extended configuration as could assist in pulling;

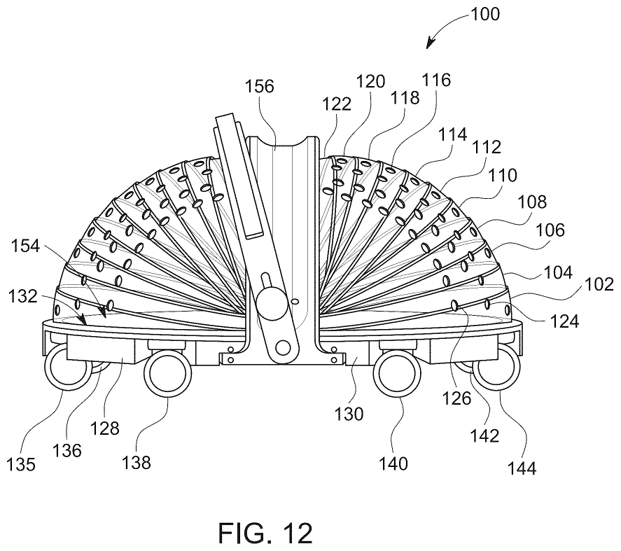

FIG. 12 is a side perspective view of a first alternatively preferred embodiment in an open configuration;

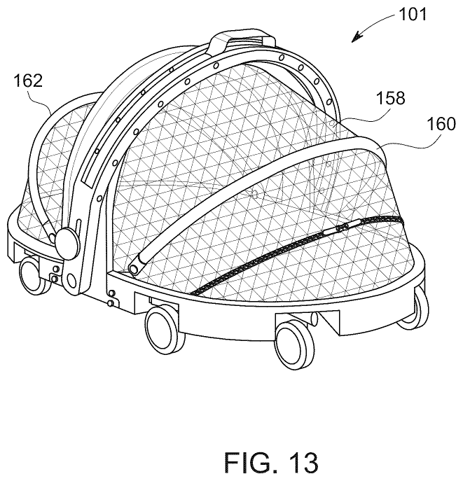

FIG. 13 is a top perspective view of a second alternatively preferred embodiment in an open configuration;

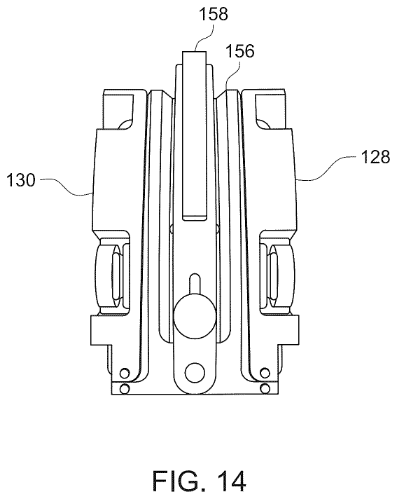

FIG. 14 is a front plan view of the alternative embodiments of FIGS. 12 and 13 in a compact configuration; and

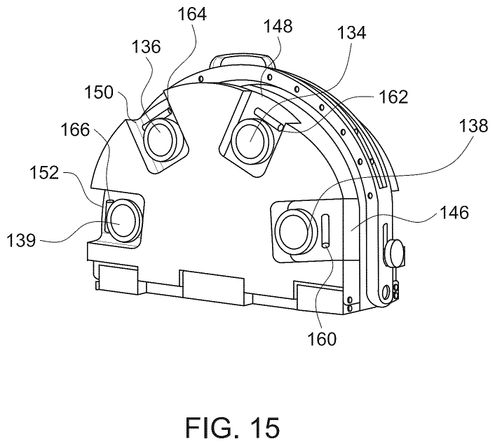

FIG. 15 is a side perspective view of the alternative embodiments in a compact configuration.

### DETAILED DESCRIPTION OF THE PREFERRED EMBODIMENT

FIG. 1 shows a pet carrier 10 in a closed configuration. Sides 12,14 are shown in a closed or compact configuration relative to a central frame 16 in both FIGS. 1 and 2.

FIG. 3 shows an open view. The side 12 (and other side 14) extends possibly in a tent-like structure possibly having fiberglass rods 20 or other structure to assist in providing a housing 18 above the side 12 in the open configuration. A door 22 may be zippered shut. To open a pull tab 26 may move along zipper 24 as would be understood by those of ordinary skill in the art. Retractable wheels 28,36 (and possibly others) may be utilized to roll the carrier 10.

FIG. 4 shows a top view of the carrier 10 with the sides 12,14 deployed relative to the frame 16. In order to move the carrier 10 it is preferable that a handle 30 could be rotated relative to frame 16 such as about pivot pin 32 with a retaining knob 34 that could potentially lock the handle in a desired angular position relative to the frame 16. Internal portions from the side view show the pin 32 with the retaining knob 34 when in a compact configuration as opposed to the extended configuration of FIG. 8 which may be useful to move the carrier from point A to point B.

FIG. 9 shows internal portions of the handle mechanism 30 which may be separate or part of the frame 16. The handle housing 40 receives a portion of the handle arm 42 which preferably locks with a spring loaded tab 44 in a compact configuration as shown in FIG. 9. The spring loaded tab 44 may be pressed and the stop 46 may be moved to an extended configuration at 48 as is shown in FIGS. 9 and 11 so as to extend the handle 30 from handle housing 40 to facilitate moving the pet carrier by giving additional length to the handle 30 relative to the base 50 of the frame 16 or other portion of the carrier 10. Internal spring 52 may assist in securing the tab 44 after moving to the desired location. The handle arm 42 may be returned back to the compact configuration by pressing the button 54 and guiding the handle arm 42 from the second position 48 back to the first position at tab 44 or otherwise.

What is achieved with this pet carrier 10 is a particularly compact configuration as shown in FIG. 2 when in a storage configuration while a fully functional configuration is shown in FIGS. 3 and 4 ready to hold a pet whereas FIGS. 5-11 shows the capability to move the pet carrier in a relatively easy fashion particularly when utilizing the rollers 28,36 shown in FIG. 3.

FIG. 12-15 show an alternatively preferred embodiment of a pet carrier 100 in an in-use configuration having hard shell segments 102-122 (possibly more or fewer could be provided with various embodiments) on each of sides 128,130 which may nest in a deployed or open configuration as illustrated to provide an enclosed volume 124 internal thereto with air holes 126 provided in at least some, if not all, of the segments 102-122. Sides 128, 130 are preferably rigid in nature to provide a base 132, like a solid base onto which a pet may be located internal to the enclosed volume 124 when stored therein. Wheels 134-144 (and/or others) may extend from base 132 downwardly and even retract into wells 146-152 when not desired to be extended. In fact, wheels 134-144 may connect to arms 160-166 which may hingedly connect at the base 132 for extension and retraction relative thereto.

A well 154 may be located in a top of the base 132 when in the open configuration as shown in FIGS. 12 and 13 which with the frame 156 may assist in receiving segments 102-122 (or other portions of sides 128,130, such as netting 158 and supports 160,162 of pet carrier 101 of FIG. 13). Other side structures could be employed with other embodiments.

FIG. 14 shows the sides 128,130 in a compact configuration with frame 156. Handle 158 may operate similarly or dissimilarly as handle in the embodiment of FIGS. 1-11.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A pet carrier comprising:
sides connected at a bottom of the sides to a frame, said sides rotatable intermediate an open configuration with the sides parallel to the frame to a compact configuration with the sides perpendicular to the frame;
a housing extending from the sides to the frame providing an enclosure therein when in the open configuration, and the housing contained internal to the sides and the frame in the compact configuration; and
a door operable from an open to a closed configuration selectively permitting entry of a pet into the enclosure.

2. The pet carrier of claim 1 wherein the sides are substantially semicircular.

3. The pet carrier of claim 1 further comprising rods assisting in defining the enclosure in the open configuration.

4. The pet carrier of claim 3 wherein the rods are fiberglass.

5. The pet carrier of claim 3 wherein the rods are contained internal to the sides and the frame in the compact configuration.

6. The pet carrier of claim 1 wherein the door is formed of a zippered portion of the housing.

7. The pet carrier of claim 1 further comprising wheels extending downwardly from the base.

8. The pet carrier of claim 7 wherein the wheels are retractable.

9. The pet carrier of claim 1 further comprising a handle connected to the frame.

10. The pet carrier of claim 9 wherein the handle has an extended and a retracted configuration.

11. The pet carrier of claim 10 further comprising a spring loaded tab which assists in maintaining the handle in at least one of the extended and retracted configurations.
